(19) United States
(12) Patent Application Publication
(10) Pub. No.: US 2020/0099289 A1
(43) Pub. Date: Mar. 26, 2020

(54) POWER MODULE

(71) Applicant: Delta Electronics, Inc., Taoyuan City (TW)

(72) Inventors: Chao YAN, Taoyuan City (TW); Liping SUN, Taoyuan City (TW)

(21) Appl. No.: 16/558,162

(22) Filed: Sep. 2, 2019

(30) Foreign Application Priority Data
Sep. 25, 2018 (CN) 201811113723.7

(51) Int. Cl. H02M 1/44

(52) U.S. Cl. CPC H02M 1/44

(57) ABSTRACT

The present disclosure provides power module, comprising at least three non-jumping power terminals at a non-jumping potential, wherein multiple power devices and at least one first capacitor are electrically connected between a first non-jumping power terminal and a second non-jumping power terminal of the at least three non-jumping power terminals; and at least one jumping power terminal at a jumping potential. A first jumping power terminal of the at least one jumping power terminal is electrically connected to one terminal of a power inductor and a third non-jumping power terminal of the at least three non-jumping power terminals is electrically connected to the other terminal of the power inductor; wherein at least one second capacitor is electrically connected between the third non-jumping power terminal and at least one of other non-jumping power terminals.

### CROSS-REFERENCE TO RELATED APPLICATIONS

This non-provisional application claims priority under 35 U.S.C. § 119(a) on Patent Application No. 201811113723.7 filed in P.R. China on Sep. 25, 2018, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### BACKGROUND OF THE INVENTION

### 1. Field of the Invention

The present invention relates to power modules, and particularly to a power module with low EMI (Electro-Magnetic Interference) noise.

### 2. Related Art

In recent years, SIC power semiconductor devices have been increasingly used in high-power power electronic converters due to their excellent switching characteristics. At present, the SIC power semiconductor devices can be a discrete component packaging, such as TO220, TO247, etc, and thereby the package is standardized, the cost is relatively low, and the reliability is relatively high. However, it also brings some problems, such as parasitic parameters (such as stray inductance) are relatively high and large EMI problems can exist in the case of large parasitic parameters application. Therefore, in some high power application, such as power of above 10 KW, SIC power modules can be applied. The power module can significantly reduce internal parasitic parameters, and it is more suitable for usage of SIC die connected in parallel. Meanwhile, the driver of the power module utilizes the Kevin connection, and the power source and the driver source are completely isolated, thus the problem of common source does not exist and the switching loss can be reduced a lot. However, since the SIC device is a high-speed wide band-gap switch device, the voltage rise rate dv/dt and the current rise rate di/dt of the switching transistor are relatively high, thus the EMI noise is relatively large. There is the same problem as in all high-speed switching devices such as GaN.

As shown FIG. 1, in which a typical half-bridge power module is shown. The half-bridge power module have three power terminals, IN+, IN−, and AC, where the AC terminal is an EMI noise source. Moreover, the half-bridge power module includes a bridge arm having two semiconductors, by integrating the two semiconductors together, the length of the wires between the two semiconductors can be reduced, and the heat dissipation problem of the switches can be solved. Meanwhile, placing a high frequency capacitor outside and connected with the power terminals can reduce the switching peak and EMI noise.

As shown FIG. 2, in which shows a conventional buck circuit including a half-bridge power module. The power module M′ includes a bridge arm having two power devices Q₁ and Q₂ connected in series, and has three power terminals of IN+, IN− and AC. The IN− and AC terminal are electrically connected to an inductor L and an output capacitor C₂, and the IN+ and IN− terminal are electrically connected to an input source Vin and an input capacitor C₁. However, due to the physical size of the power module M′ itself, the stray inductance of the first loop C_{L1}, which includes power devices Q₁ and Q₂, and capacitor C₁, will be relatively large and thus affect EMC (Electro-Magnetic Compatibility) characteristics. In prior art, the high-frequency ceramic capacitor C₁ can be integrated inside the half-bridge power module and disposed at the position closest to the power terminals IN+ and IN− of the power devices Q₁ and Q₂, as shown in FIG. 3, which can greatly absorb excessive high voltage overshooting and therefore improves system reliability. However, the second loop C_{L2} indicated in FIG. 2 has a parasitic parallel capacitance C_{L} of the output inductor L and a loop parasitic inductance (not shown), therefore the noise of high frequency on the AC terminal passes from the parasitic C_{L} to the IN− terminal, which also causes high frequency EMC problems.

Specifically, as shown FIG. 4, in which shows an EMI analysis circuit of a half-bridge power module M′ applied in a typical buck circuit application, which includes a buck circuit, a primary EMI filter, an EMI LSIN, and an output impedance. Wherein Cₚₐᵣₐ₁ is the parasitic capacitor of the power inductor L. Lₚₐᵣₐ₁ is the parasitic inductance between a terminal A2 of capacitor C_{X1} and the fixed point A3 of power module M′, and Lₚₐᵣₐ₂ is the parasitic inductance between the point A1 and the capacitor C_{X1}.

Moreover, at high frequency, the impedance of the power inductor L is very large, while the impedance of the capacitor C_{X1} is very small. The voltage across A1A2 and the voltage across A2A3 are approximately calculated as below:

V_{A1A2}=Vₙₒᵢₛₑ*ZLₚₐᵣₐ₂/(ZLₚₐᵣₐ₁+ZCₚₐᵣₐ₁+ZLₚₐᵣₐ₂)

V_{A2A3}=Vₙₒᵢₛₑ*ZLₚₐᵣₐ₁/(ZLₚₐᵣₐ₁+ZCₚₐᵣₐ₁+ZLₚₐᵣₐ₂)

Wherein, Vₙₒᵢₛₑ is the noise voltage between the AC terminal and the IN-terminal. ZLₚₐᵣₐ₁, ZLₚₐᵣₐ₂, and ZCₚₐᵣₐ₁ are the impedances of parasitic inductance Lₚₐᵣₐ₁, parasitic inductance Lₚₐᵣₐ₂, and parasitic capacitance Cₚₐᵣₐ₁, respectively. The voltage V_{A1A2} of A1A2 is converted into differential mode noise, and the voltage V_{A2A3} of A2A3 is converted into common mode noise. Given above, the higher the frequency is, the greater the impedance of the inductance (for example, the parasitic inductance Lₚₐᵣₐ₁ and the parasitic inductance Lₚₐᵣₐ₂) and the greater the noise are.

Therefore, there is an urgent need for a power module with low EMI noise.

### SUMMARY OF THE INVENTION

In view of this, the present invention intends to provide a power module, which has low EMI noise and can greatly reduce engineers' time for solving EMI.

In order to realize the above purpose, the present invention provides a power module, wherein the power module comprising:

at least three non-jumping power terminals at a non-jumping potential, wherein multiple power devices and at least one first capacitor are electrically connected between a first non-jumping power terminal and a second non-jumping power terminal of the at least three non-jumping power terminals; and

at least one jumping power terminal at a jumping potential, wherein a first jumping power terminal of the at least one jumping power terminal is electrically connected to one terminal of a power inductor and a third non-jumping power terminal of the at least three non-jumping power terminals is electrically connected to the other terminal of the power inductor;

wherein at least one second capacitor is electrically connected between the third non-jumping power terminal and at least one of other non-jumping power terminals of the at least three non-jumping power terminals.

The present invention adds at least one non-jumping power terminal based on the existing power module technology, and the non-jumping power terminal and a jumping power terminal are respectively electrically connected to two terminals of a power inductor; and the present invention also adds a high frequency capacitor between the non-jumping power terminal and at least one of other non-jumping power terminals, therefore further reduces EMI noise and significantly saves engineers time for solving EMI.

The above description will be further described in detail below, as well as the further interpretation of the technical solution of the present invention will be provided

### BRIEF DESCRIPTION OF THE DRAWINGS

To make the above and other objects, features, advantages and examples of the invention more apparent and straightforward, a brief description of the drawings is provided as follows:

FIG. 1 is a schematic diagram of the structure of a conventional half-bridge power module;

FIG. 2 is a circuit schematic diagram of a conventional power module applied in the typical buck circuit;

FIG. 3 is a schematic diagram of the structure of a power module of the existing integrated high frequency capacitors;

FIG. 4 is a schematic diagram of an EMI analysis circuit of a conventional power module applied in a typical buck circuit;

FIG. 5 is a schematic diagram of the structure of a power module according to a preferred embodiment of the present invention;

FIGS. 6a-6c are voltage schematic diagrams of the non-jumping pin of FIG. 5 with respect to a reference point;

FIG. 7 is a schematic diagram of an EMI analysis circuit of a power module applied in a typical buck circuit according to the present invention.

FIG. 8 is a waveform schematic diagram obtained by performing RFI testing of the power module under a first-stage EMI filter according to the present invention.

FIGS. 9a-9h are schematic diagrams of a topology circuit of a power module according to another preferred embodiment of the present invention;

FIG. 10 is a schematic diagram of an optimized circuit of a power module according to another preferred embodiment of the present invention.

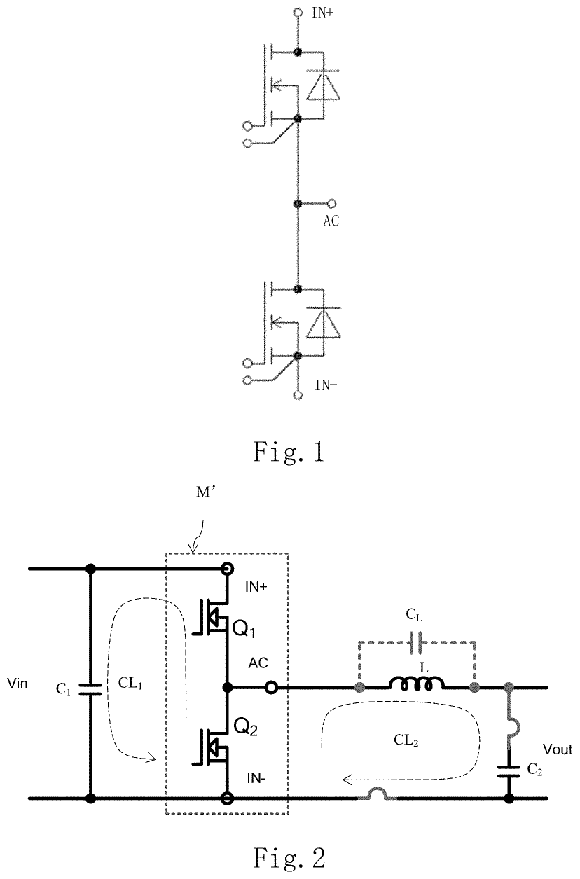

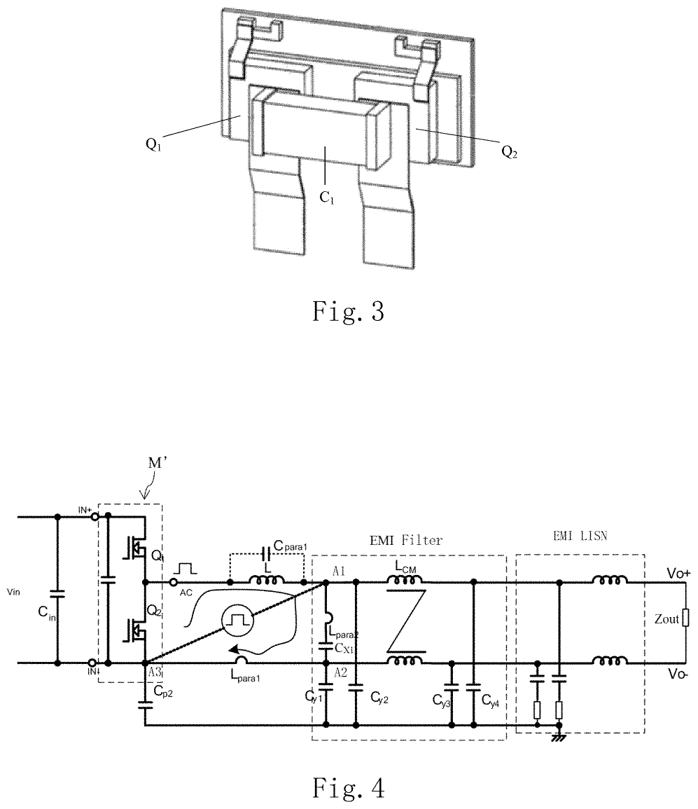

### DETAILED DESCRIPTION OF THE INVENTION

In order to make the description of the invention more elaborate and complete, reference may be made to the accompanying drawings and the various examples described below, and the same numbers in the drawings represent the same or similar components. On the other hand, well-known components and steps are not described in the examples to avoid unnecessarily limiting the invention. In addition, some of the conventional structures and elements already known are shown in the drawings in a simplified schematic manner to simplify the drawings.

The power module of the present invention has at least three non-jumping power terminals and at least one jumping power terminal. Wherein, the at least three non-jumping power terminals are at non-jumping potentials, and multiple power devices and at least one first capacitor are electrically connected between a first non-jumping power terminal and a second non-jumping power terminal. At least one jumping power terminal is at a jumping potential. A first jumping power terminal is electrically connected to one terminal of a power inductor and a third non-jumping power terminal is electrically connected to the other terminal of the power inductor. And at least one second capacitor are electrically connected between the third non-jumping power terminal and at least one of other non-jumping power terminals.

In the present invention, the “non-jumping potential” generally refers to a potential, which is at fixed potential or has tiny high-low level jumping with respect to a reference potential point. The tiny high-low level jumping can be, for example, a voltage rising rate dv/dt less than 2V/us. The “jumping potential” generally refers to having a large high-low level jumping with respect to the reference potential point. The large high-low level jumping can be, for example, the voltage rising rate dv/dt greater than 10 V/us. In one embodiment, the threshold values of the above voltage rising rate dv/dt, such as 2V/us or 10V/us, may also be variable fluctuate within a certain range, such as, but not limited to, ten percent, or five percent of 2V/us or 10V/us etc.

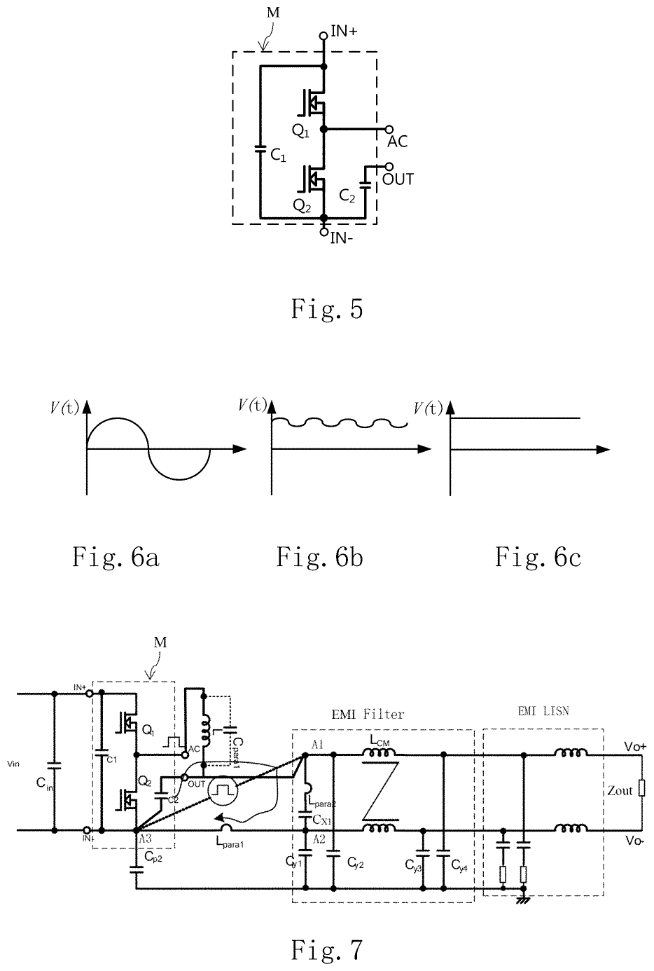

As shown FIG. 5, in which shows a structure of a power module according to a preferred embodiment of the present invention. The power module M includes four power terminals, that is, terminals IN+, IN−, AC and OUT. Wherein terminals IN+, IN− and OUT are non-jumping power terminals at a non-jumping potential, and the terminal AC is jumping terminal at a jumping potential. In this embodiment, two power devices Q₁ and Q₂ and a capacitor C₁ are electrically connected between terminals IN+ and IN−. The above two power devices Q₁ and Q₂ are connected in series and configured as a bridge arm. The capacitor C₁ is connected in parallel with this bridge arm, and terminals AC and OUT are used to respectively electrically connect to both two terminals of a power inductor, and a capacitor C₂ is also electrically connected between terminals OUT and IN−.

In this embodiment, terminals IN+, IN−, AC, and OUT are respectively power terminals with current values greater than 1A. Wherein terminals IN+, OUT, and IN− are terminals at a fixed potential, for example, the terminal IN− serves as the reference point at a reference potential (such as a zero potential). Terminals IN+ and OUT are also at fixed potentials with respect to the terminal IN−, which is shown in FIG. 6c. The terminal AC has a relative large high-low level jumping with respect to the terminal IN− (reference point), that is, there is a relative large voltage rising rate dv/dt between AC and IN− (for example, dv/dt>10V/us), which is the noise source of EMI. In other embodiments, terminals IN+, OUT, and IN− may also be sinusoidal ripples superimposed with a frequency <10 kHz, and the voltage rising rate dv/dt is relatively small, such as less than 2V/us, as shown in FIG. 6b. In other embodiments, with respect to the terminal IN−, the terminal OUT also may also be provided with an AC voltage with a frequency <10 kHz, which is also shown in FIG. 6a.

Preferably, in an embodiment of the invention, the capacitors C₁, C₂ may be high frequency capacitors. More preferably, the capacitor C₂ can be a SMC or a capacitor die, and the value of the capacitor can be, for example, greater than 1 nF.

As shown FIG. 7, in which shows an EMI analysis circuit of a power module applied in a typical buck circuit according to the present invention. Wherein, with respect to the conventional power module M′ shown in FIG. 4, a power terminal OUT and a capacitor C₂ are added to the power module M of the present invention, and the capacitor C₂ is a high frequency capacitor with a parasitic inductance <1 nH. The value of the capacitor C₂ is much larger than the parasitic capacitance Cₚₐᵣₐ₁ of the power inductor L. The parasitic inductances Lₚₐᵣₐ₁ and Lₚₐᵣₐ₂ are relatively small, so in high frequency, the impedance at both terminals of A1A2 is approximately equal to the impedance ZC₂ of the capacitor C₂ and the voltage V_{A1A3} across A1A3 is approximated equals to Vₙₒᵢₛₑ*ZC₂/(ZC₂+ZCₚₐᵣₐ₁). Since ZC₂ is much smaller than ZCₚₐᵣₐ₁, the noise amplitude at across A1A3 is significantly reduced.

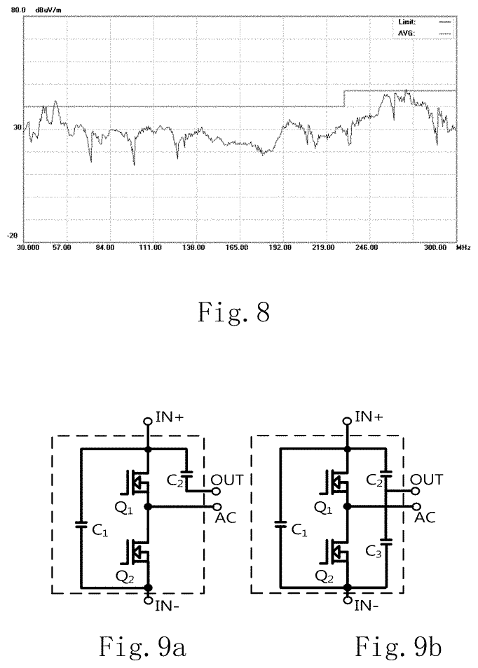

FIG. 8 is a waveform schematic diagram obtained by performing RFI testing on the power module under a first-stage EMI filter according to the present invention. Using the connection mode of the power module of the present invention, the waveform of the RFI is obtained from the test under the topology of the high-speed switching device GaN, as shown in FIG. 8. Seen from the waveform, the above power supply under first-level EMI filtering could satisfy the Class B standard.

It can be understood that the power module of the present invention is not limited to the above topology, and it can be widely applied to topologies such as boost, buck, Herric, and T-type three level, etc. At least one jumping node and at least three non-jumping nodes should be included in each topology. Moreover, the power terminal of the power module of the present invention in each topology should include both terminals of the power inductor and a non-jumping power terminal.

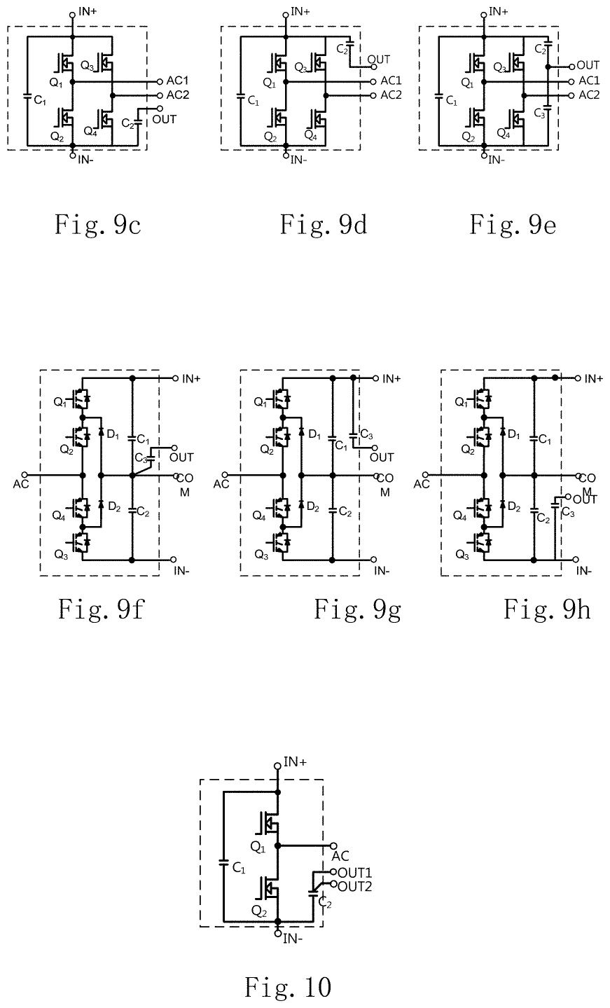

As shown FIGS. 9a to 9h, it shows topology circuits of the power modules according to other preferred embodiments.

As shown FIGS. 9a to 9b, the difference between the power module thereof and that shown in FIG. 5 is that: in the power module shown in FIG. 9a, the capacitor C₂ is electrically connected between terminals OUT and IN+; In the power module shown in FIG. 9b, the capacitor C₂ is electrically connected between terminals OUT and IN+, and the capacitor C₃ is electrically connected between terminals OUT and IN−.

As shown in FIG. 9c to FIG. 9e, the difference between the power module thereof and that shown in FIG. 5 is that: the power module shown in FIG. 9c to FIG. 9e includes two half-bridge arms between terminals IN+ and IN−, which respectively includes power devices Q₁ and Q₂ connected in series, and Q₃ and Q₄ connected in series. And terminals AC1 and AC2 terminal at a jumping potential are the center points of the two half-bridge arms respectively. Moreover, in the power module shown in FIG. 9c, the capacitor C₂ is electrically connected between terminals OUT and IN−; in the power module shown in FIG. 9d, the capacitor C₂ is electrically connected between terminals OUT and IN+. In the power module shown in FIG. 9e, the capacitor C₂ is electrically connected between terminals OUT and IN+, and the capacitor C₃ is electrically connected between terminals OUT and IN−.

As shown in FIG. 9f to FIG. 9h, the difference between the power module thereof and that shown in FIG. 5 is that: the power module shown in FIG. 9f to FIG. 9h includes a full-bridge arm between terminals IN+ and IN−, which includes power devices Q₁, Q₂, Q₃ and Q₄ connected in series. The power module further includes a first bridge arm having diodes D₁ and D₂ connected in series, which is connected in parallel with both terminals of the power devices Q₂ and Q₃. A second bridge arm having capacitors C₁ and C₂ connected in series is included between terminals IN+ and IN−, and the terminal COM at a non-jumping potential is a center point of the first bridge arm and the second bridge arm. Also, in the power module shown in FIG. 9f, the capacitor C₃ is electrically connected between the terminal OUT and the second bridge arm. In the power module indicated in FIG. 9g, the capacitor C₃ is electrically connected between terminals OUT and IN+ terminals. In the power module indicated in FIG. 9h, the capacitor C₃ is electrically connected between terminals OUT and IN−.

As shown in FIG. 10, in order to better optimize the effect of EMI, the present invention can also add a power terminal OUT2 as an auxiliary terminal on the terminal of the capacitor C₂, and the terminal OUT2 is electrically connected to the OUT1 terminal. The terminals AC and OUT1 are electrically connected at both terminals of the power inductor (such as the power inductor L in FIG. 7), and the terminal OUT2 is a non-jumping power terminal and is connected to one terminal of the external capacitor (such as capacitor C_{X1} in FIG. 7). This minimizes the equivalent inductance of C₂, and compared with the power module shown in FIG. 5, EMI noise is less.

It can be understood that all the embodiments including the embodiment shown in FIG. 9a to FIG. 9h can change the output power terminal from one to two in the manner of FIG. 10, and those are not considered as the limitation of the present invention. Moreover, when making the layout of the power module shown in FIG. 5, in order to optimize EMI, one terminal of the power inductor and one terminal of the external capacitor may be respectively connected to the terminal OUT of the power module.

While the invention has been disclosed in the above implementations, it is not intended to limit the invention, and various modifications and retouches may be made by those skilled in the art without departing from the spirit and scope of the invention. The scope of protection of the invention therefore is subject to the scope defined by the appended claims.

What is claimed is:

1. A power module, comprising:
at least three non-jumping power terminals at a non-jumping potential, wherein multiple power devices and at least one first capacitor are electrically connected between a first non-jumping power terminal and a second non-jumping power terminal of the at least three non-jumping power terminals; and
at least one jumping power terminal at a jumping potential, wherein a first jumping power terminal of the at least one jumping power terminal is electrically connected to one terminal of a power inductor and a third non-jumping power terminal of the at least three non-jumping power terminals is electrically connected to the other terminal of the power inductor;
wherein at least one second capacitor is electrically connected between the third non-jumping power terminal and at least one of other non-jumping power terminals of the at least three non-jumping power terminals.

2. The power module according to claim 1, wherein a terminal of the second capacitor that is electrically connected to the third non-jumping power terminal is further provided with an auxiliary terminal, the auxiliary terminal being electrically connected to a terminal of an external capacitor.

3. The power module according to claim 1, wherein the first non-jumping power terminal is used as a reference point at a reference potential; and
the jumping power terminal has a high-low level jumping with respect to the reference point with a voltage rising rate greater than 10V/us.

4. The power module according to claim 3, wherein the non-jumping power terminal is at a fixed potential with respect to the reference point; or has a sinusoidal ripple with a frequency less than 10 kHz with respect to the reference point with the voltage rising rate less than 2V/us; or is provided with an AC voltage with a frequency less than 10 KHz with respect to the reference point.

5. The power module according to claim 3, wherein the first capacitor and the second capacitor are high frequency capacitors.

6. The power module according to claim 1, wherein the value of the second capacitor is greater than 1 nF.

7. The power module according to claim 1, wherein the second capacitor is a Surface Mount Capacitor (SMC) or a capacitor die.

8. The power module according to claim 1, wherein the multiple power devices include at least one bridge arm, and each bridge arm includes at least two power devices connected in series.

9. The power module according to claim 1, wherein the power module is a high frequency switching power module.

10. The power module according to claim 8, wherein the first jumping power terminal of the at least one jumping power terminal is a center point of the bridge arm.

11. The power module according to claim 1, wherein the at least three non-jumping power terminals further includes a fourth non-jumping power terminal, wherein at least one third capacitor is electrically connected between the fourth non-jumping power terminal and at least one of other non-jumping power terminals excluding the third non-jumping power terminal among the at least three non-jumping power terminals.

12. The power module according to claim 1, wherein the at least three non-jumping power terminals further includes a fifth non-jumping power terminal, the fifth non-jumping power terminal and the third non-jumping power terminal being electrically connected.
